(19) United States
(12) Patent Application Publication
(10) Pub. No.: US 2009/0113281 A1
(43) Pub. Date: Apr. 30, 2009

(54) Identifying And Displaying Tags From Identifiers In Privately Stored Messages

(76) Inventors: Tyler Close, Menlo Park, CA (US); Craig Sayers, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/254,957

(22) Filed: Oct. 21, 2008

Related U.S. Application Data
(60) Provisional application No. 61/034,069, filed on Mar. 5, 2008.
(60) Provisional application No. 60/984,219, filed on Oct. 31, 2007.

(51) Int. Cl. G06F 17/30; G06F 17/00

(52) U.S. Cl. 715/205; 707/103 R; 707/E17.009

(57) ABSTRACT

In a computerized method of identifying and displaying tags that represent respective identifiers in messages privately stored in a message store for restricted access by a user, at least one document identifier is discovered. The message store is scanned to identify messages containing the at least one document identifier and one or more identifiers in the messages identified as containing the at least one document identifier are identified. In addition, respective tags associated with the one or more identifiers are created and displayed in a tag area.

### CROSS-REFERENCE TO RELATED APPLICATION

The present application claims priority from provisional application Ser. No. 61/034,069, filed Mar. 5, 2008, the contents of which are incorporated herein by reference in its entirety.

This application contains similar disclosure to commonly assigned and co-pending U.S. Provisional Patent Application Ser. No. 60/984,219 (Attorney Docket No. 200703072), filed on Oct. 31, 2007, the disclosure of which is hereby incorporated by reference in its entirety.

### BACKGROUND

Electronic mail (e-mail) and other types of computerized communication tools have ever-increasingly become effective means by which users communicate with each other. In fact, it is now commonplace for users to receive dozens of e-mails in one or more e-mail accounts every day ranging among a variety of different topics. As such, a user's inbox quickly becomes filled with numerous e-mails and thus becomes difficult to manage.

A common attempt at overcoming the difficulty in managing the e-mails is for the user to organize e-mails into a number of different folders. This requires that the user sort through the e-mails and place the e-mails into the appropriate folders, which is both time-consuming and laborious. This approach may be effective for those e-mails that pertain to a specific topic having a relatively long period of relevance, and can thus easily be sorted into the different folders. However, if an e-mail is relevant to more than one topic and is thus suitable for insertion into multiple folders, the user may find it difficult to determine which of the folders that e-mail is to be inserted. In addition, if the user receives a number of e-mails pertaining to a number of different topics, each having a relatively short period of relevance, the user will be required to create a relatively large number of new folders for each of the different topics, which is a relatively cumbersome task.

Moreover, when a user would like to identify those e-mails pertaining to a common topic, the user may relatively easily perform a search for those e-mails by manually inserting the topic into a search field. The e-mail or other computerized communication tool returns only those e-mails containing the inserted topic. As such, in order for users to identify whether those e-mails contain any other topics relevant to the inserted topic, the user must manually go through all of those e-mails, which is a time-consuming and laborious task.

It would therefore be desirable to be able to quickly and efficiently identify which additional topics are relevant to a particular topic without requiring the time consuming and laborious sorting operations currently being performed to manage e-mails.

### BRIEF DESCRIPTION OF THE DRAWINGS

Features of the present invention will become apparent to those skilled in the art from the following description with reference to the figures, in which:

FIG. 1 shows a simplified block diagram of a system for identifying and displaying tags represent respective identifiers in messages that are privately stored for restricted access by a user that are relevant to at least one document identifier, according to an embodiment of the invention;

FIG. 2A illustrates a screenshot of a navigation area window and a messaging area window, according to an embodiment of the invention;

FIGS. 2B and 2C illustrate respective screenshots of windows of messages depicted with pop-up tag areas, according to embodiments of the invention;

FIG. 3 illustrates a flow diagram of a method of identifying and displaying tags that represent respective identifiers in messages that are privately stored in a message store for restricted access by a user, according to an embodiment of the invention;

FIG. 4 shows a flow diagram of a method of displaying a tag area on a computing apparatus having a relatively small display, according to an embodiment of the invention; and

FIG. 5 shows a block diagram of a computing apparatus configured to implement one or more of the methods discussed with respect to FIGS. 3 and 4, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are computerized methods and systems for identifying and displaying tags that represent respective identifiers in messages privately stored in a message store for restricted access by a user. Generally speaking, in the systems and methods disclosed herein, one or more document identifiers of a document are discovered. The one or more document identifiers may comprise identifiers depicted in an address line of a browser, identifiers of results displayed in the document, and associated identifiers, such as those found while following a redirection chain. In addition, the one or more document identifiers may be discovered through receipt of a user selection of the one or more document identifiers.

In addition, messages stored in a message store containing the one or more document identifiers are automatically identified. Those messages identified as containing the one or more identifiers are evaluated to determine whether they contain one or more identifiers other than the one or more document identifiers. Moreover, respective tags associated with the one or more identifiers contained in the messages are created and displayed, for instance, in a messaging area window, in a pop-up window, in a new window, etc.

The tags generally comprise descriptors of the respective identifiers, such as, single word descriptions, portions of the identifiers, etc., which may be displayed with features that distinguish certain tags from other tags. The tags may also comprise hyperlinks that cause documents associated, with the respective identifiers to be displayed, for instance, in a navigation area result window when activated. In one regard, therefore, the methods and systems disclosed herein may be implemented as part of an organizational tool that automatically identifies and displays tags in accordance messages relevant to a particular topic of interest to the user.

According to various examples discussed herein below, the messages are e-mail or other electronic messages and the message store is private to the user. The message store may thus be located on the user's computing apparatus and thus accessible by the user only. In addition, or alternatively, the message store may be stored remotely with access to the message store restricted to the user. This “private” arrangement provides for a number of benefits in terms of also implementing the systems and methods disclosed herein as a collaboration tool. In one respect, because the messages comprise e-mail messages, which may be communicated through existing e-mail messaging systems, the messages are communicated from one user to another or by a user to be stored in the message store, while following the security and legal conformance policies of the e-mail application and those policies set forth by individual organizations. In addition, users are able to select the intended recipients of the messages, and thus may substantially control access to individual messages, as well as to substantially control who may contribute to the collaboration. In one regard, collaboration among the users is facilitated through communication and automatic organization of the messages to the intended recipients.

One benefit of including the message store locally on the user's computing apparatus is that it enables a user to read and write messages offline. In addition, either of the private arrangements discussed above enables the message store to have a higher level of security since the information contained therein is not shared among a number of users.

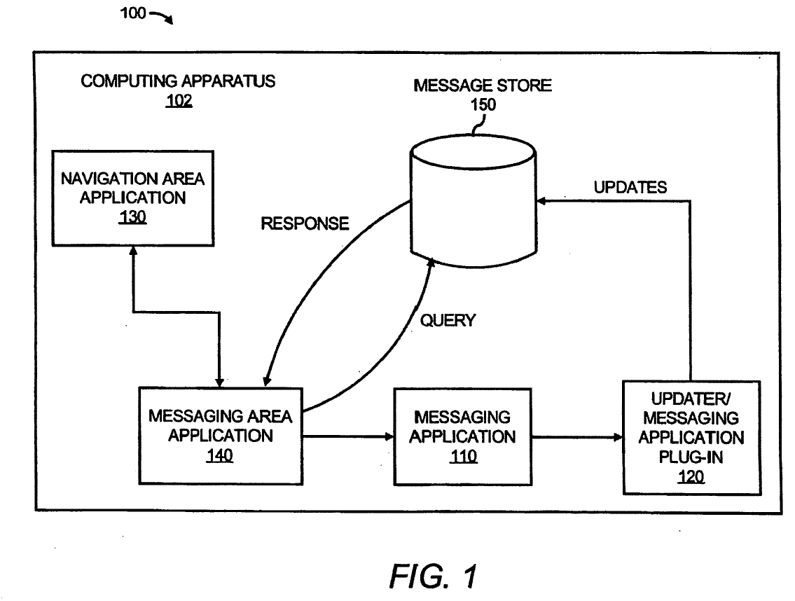

With reference first to FIG. 1, there is shown a simplified block diagram of a system 100 for identifying and displaying tags that represent respective identifiers in messages that are privately stored for restricted access by a user and that are relevant to at least one document identifier, according to an example. It should be understood that the system 100 may include additional components and that some of the components described herein may be removed and/or modified without departing from the scope of the system 100. For instance, the system 100 may include any number of additional applications or software configured to perform any number of other functions.

Generally speaking, the system 100 includes a plurality of applications that may be stored on a computer readable storage medium. The computer readable storage medium may comprise computer system RAM, ROM, EPROM, EEPROM, and removable computer readable storage media, such as, magnetic disks, optical disks, tapes, etc. As such, the computer readable storage medium may comprise a storage device or memory of the user's computing apparatus 102 or it may comprise a removable storage device having applications stored thereon configured to be executed in the user's computing apparatus 102. The user's computing apparatus 102 may comprise, for instance, a desktop computer, a laptop computer, a tablet PC, a personal digital assistant, a cellular telephone, etc. In this regard, one or more processors of the user's computing apparatus 102 may execute or implement the applications contained in the system 100.

As shown, the system 100 includes a messaging application 110, an updater/messaging application plug-in 120, a navigation area (NA) application 130, a messaging area application 140, and a message store 150. The messaging application 110 generally comprises any reasonably suitable application that enables communication over a network, such as, an intranet, the Internet, etc., through the user's computing apparatus 102, for instance, an e-mail application, a chat messaging application, a text messaging application, etc.

The updater/messaging application plug-in 120 generally comprises a plug-in of the messaging application 110. The updater/messaging application plug-in 120 is configured to monitor all of the messages that are received and generated by the messaging application 110. The updater/messaging application plug-in 120 is also configured to update the messages stored in the message store 150. According to an example, the messaging application 110 may directly update messages that are received and generated by messaging application 110 in the message store 150 without requiring operation of the updater/messaging application plug-in 120.

The navigation area application 130 generally comprises any reasonably suitable application that enables a user to access a network through the user's computing apparatus 102. In this regard, the navigation area application 130 may comprise, for instance, a web browser, a file browser, etc. In addition, the navigation area application 130 is configured to display a browser window on the user's computing apparatus 102 of the user's interaction with programs or files in a web browser, a file browser, etc. The file browser may enable the user to browse through files stored locally on the user's computing apparatus 102 or through files stored externally, for instance, on a shared server.

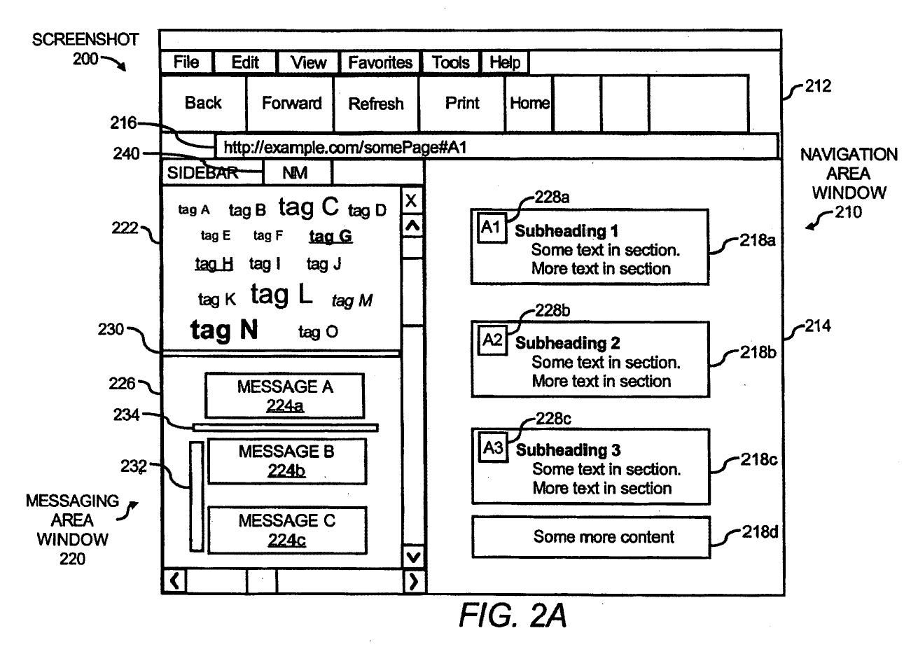

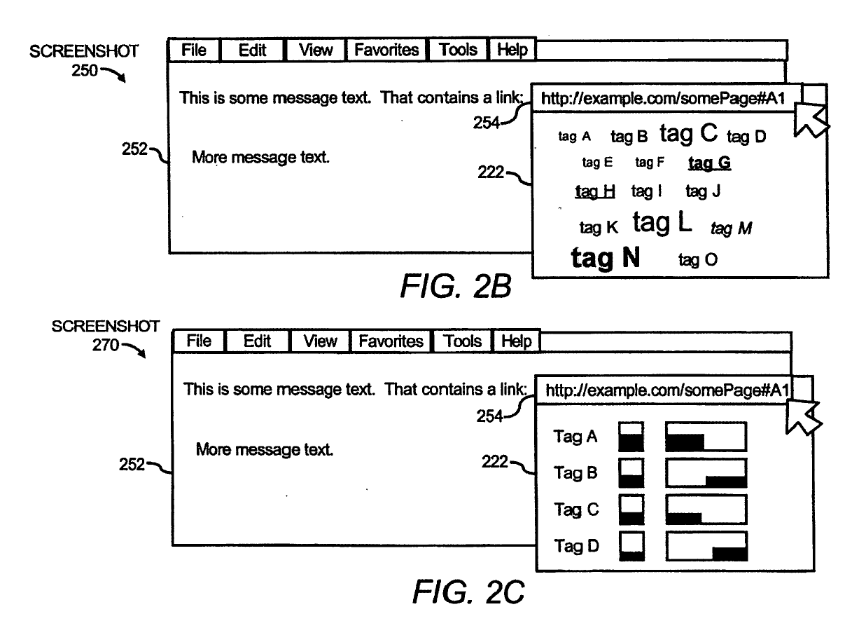

The messaging area application 140 may comprise a plug-in of the navigation area application 130. The messaging area application 140 is generally configured to monitor the user's activity in a result window 214 of a navigation area window 210 (FIG. 2). For instance, the messaging area application 140 is configured to identify one or more document identifiers of the programs or files that the user accesses in the navigation area result window 214. The one or more document identifiers may include a unique identifier of the document or an object contained in the document displayed in the navigation area result window 214. The unique identifier may comprise, for instance, a Uniform Resource Identifier (URI), a Uniform Resource Locator (URL), a Uniform Resource Name (URN), or other machine-readable identifier, such as, a patent number, an ISBN, etc. Although particular reference is made to “documents” throughout the present disclosure, it should be understood that the term “documents” also include web pages, folders, or other types of electronic media that may be displayed in the navigation area result window 214.

The messaging area application 140 is also configured to perform queries in the message store 150 to identify those messages relating to the one or more identifiers of the document or section of the document displayed in the navigation area window. The messaging area application 140 is, for instance, configured to identify those messages containing the same one or more document identifiers as the document or section of the document displayed in the navigation area result window 214. By Way of example, the messaging area application 140 is configured to identify those messages containing the same URLs as the URL of the document displayed in the navigation area result window 214. As another example, the messaging area application 140 is configured to identify those messages containing the same URLs as the URLs contained in the document displayed in the navigation area result window 214.

The messaging area application 140 is further configured to discover one or more identifiers in the messages identified as containing the one or more document identifiers. The one or more identifiers may comprise any of the unique identifiers discussed above with respect to the document identifier. As such, the one or more identifiers may comprise the same format as the document identifier, but comprise separate identifiers. In addition, the messaging area application 140 is configured to create at tag associated with each of the one or more identifiers and to display the tags in a tag area, such as, a tag cloud, in a messaging area window 220 (FIG. 2) on the user's computing apparatus 102.

According to an example, the messaging area application 140 is configured to display the results of the query of the message store 150 in the messaging area window 220. The messaging area application 140 may further format the results of the query displayed in the messaging area window 220.

According to another example, the messaging area application 140 may comprise a plug-in of the messaging application 110. In this example, the messaging area application 140 is configured to monitor the user's activity in the messaging application 110. Thus, for instance, the messaging area application 140 may monitor the user's activity in one or more messages displayed on a display of the computing apparatus 102. In addition, the messaging area application 140 is configured to identify one or more document identifiers that the user accesses in the one or more messages. The one or more document identifiers may comprise any of the identifiers discussed above.

As also discussed above, the messaging area application 140 is configured to perform queries in the message store 150 to identify those messages relating to the one or more document identifiers. The messaging area application 140 is, for instance, configured to identify those messages containing the same one or more document identifiers as contained in the one or more messages. By way of example, the messaging area application 140 is configured to identify those messages containing the same URLs as a URL (or other link) contained in the one or more messages.

The messaging area application 140 is further configured to discover one or more identifiers in the messages identified as containing the one or more document identifiers. The one or more identifiers may comprise any of the unique identifiers discussed above with respect to the document identifier. In addition, the messaging area application 140 is configured to create at tag associated with each of the one or more identifiers and to display the tags in a tag area, such as, a tag cloud, a pop-up window containing a tag cloud, an area containing graphical information pertaining to the tags, etc.

The message store 150 comprises a database that is private to a particular user. As shown in FIG. 1, the message store 150 may be locally stored in the user's computing apparatus 102. Alternatively, however, the message store 150 may be stored remotely from the computing apparatus 102. In this instance, access to the message store 150 may be restricted to the user through any conventional means, such as, through password protection. Also in this example, the messaging application 110 (and/or the updater/messaging application plug-in) may also be remotely located from the computing apparatus 102, such as, with web-based email applications.

In any event, the message store 150 may store an index of the messages and/or the messages themselves transmitted to and from the messaging application 110. The updater/messaging application plug-in 120 may update the messages stored in the message store 150 as the messages are modified in the messaging application 110. Alternatively, the updater/messaging application plug-in 120 may create an index of all of the messages that are transmitted to and from the messaging application 110 and may store the index in the message store 150. According to an example, the messages may be indexed according to the identifiers, such as, URIs, contained in the messages. In addition, the updater/messaging application plug-in 120 may update the index of the messages contained in the message store 150 as new messages are transmitted from and received by the messaging application 110. Moreover, the updater/messaging application plug-in 120 may update messages in the index if they are touched, modified, or moved by the messaging application 110, and may remove messages from the index in response to those messages being deleted by the messaging application 110.

With particular reference now to FIG. 2A, there is shown a screenshot 200 of a navigation area window 210 and a messaging area window 220, according to an example. As shown in FIG. 2, the navigation area window 210 may comprise a web browser, such as, INTERNET EXPLORER, MOZILLA FIREFOX, or other type of web browser. In addition, or alternatively, the navigation area application 130 may comprise a file browser, such as, WINDOWS EXPLORER, or other type of file browser. In either case, the messaging area window 220 may comprise a sidebar in the navigation area window 210.

The navigation area window 210 is depicted as including a heading section 212 and a result window 214. As found in conventional web browser and file browser interfaces, the heading section 212 may include a plurality of buttons that, when selected, cause the web browser or file browser to perform any of a number of different common tasks, such as, printing, moving forward or backwards through different files, etc. In addition, the heading section 212 is depicted as including a text box 216 for receiving input from a user, such as, a URL address or a file name. The text box 216 may also display the URI of the document being displayed inside in the result window 214.

The messaging area window 220 is depicted as displaying a plurality of tags (tags A-O) in a tag area 222 in the form of a tag cloud. The messaging area window 220 is also depicted as optionally displaying a plurality of messages 224a-224c in a messaging window 226. The tag area 222 is depicted as being separated from the messaging window 226 by a visual separator 230. Various manners in which the tags are created and displayed in the tag area 222 are described herein below.

The messages 224a-224c are considered optional because the tags may be generated and displayed without requiring display of the messages 224a-224c. In instances where the messages 224a-224c are displayed, the messages 224a-224c may comprise, for instance, those messages identified as including one or more of the document identifiers of the document displayed in the result section 214. The one or more document identifiers may comprise identifiers recited in an address line of a browser, identifiers of results displayed in the document, and associated identifiers, such as those found while following a redirection chain. In addition, the messages 224a-224c may be sorted in the messaging area window 220 in any of a variety of different manners, such as, by date, by name, by relevance to the one or more document identifiers, etc.

Turning now to FIGS. 2A and 2B, there are shown respective screenshots 250 and 270 of windows 252 of messages depicted with pop of tag areas 222, according to two examples. The windows 252 may comprise displays of messages received by and/or created by the messaging application 110, such as, e-mail messages, text messages, chat messages, etc. As shown in FIGS. 2A and 2B, the windows 252 include text that contains a document identifier 254, in this case, a link to a URL.

FIGS. 2B and 2C also depict tag areas 222 that are displayed when a user selects the document identifier 254. The tag areas 222 are displayed as windows that may “pop-up” on top of the window 252 or at another location in a display of the computing apparatus 102. FIG. 2B depicts the tags in the form of a tag cloud, similar to the tag cloud in FIG. 2A, and thus some of the tags may be distinguished from each other as discussed above with respect to FIG. 2A. FIG. 2C depicts the tags along with graphical information of the tags. The graphical information may display, for instance, the relevance or popularities of the respective tags to the one or more document identifiers, weight vectors for each of the identifiers based upon one or more characteristics, etc. Additional examples of information that may be graphically displayed in the tag area 222 are provided herein below.

Various manners in which the components of the system 100 depicted in FIG. 1 may be implemented are described with respect to the following figures. In addition, the following figures are described with respect to the screenshots 200, 250, and 270 depicted in FIGS. 2A-2C, respectively. It should, however, be understood that the methods described with respect to the following figures may be performed with respect to windows having configurations that differ from those depicted in FIGS. 2A-2C, without departing from the scopes of the following methods. It should also be apparent to those of ordinary skill in the art that the methods discussed below represent generalized illustrations and that other steps may be added or existing steps may be removed, modified or rearranged without departing from the respective scopes of the methods.

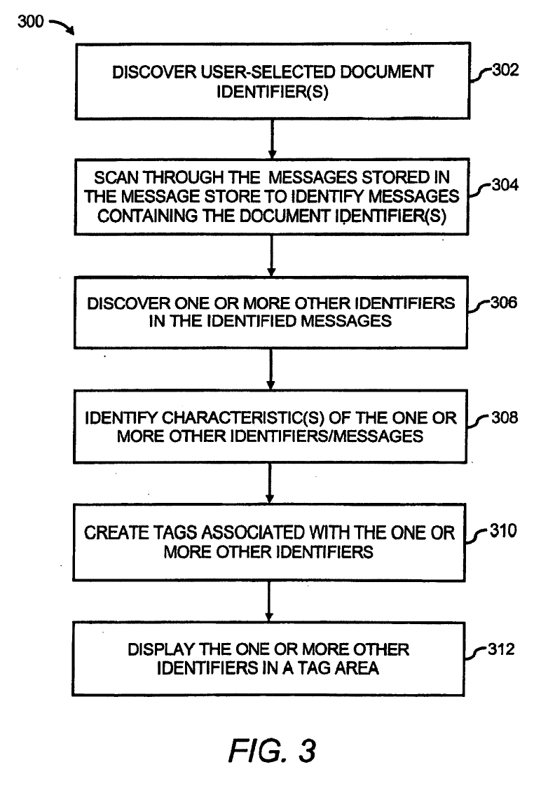

With reference first to FIG. 3, there is shown a flow diagram of a method 300 of identifying and displaying tags that represent respective identifiers in messages that are privately stored in a message store for restricted access by a user, according to an example. Generally speaking, one or more of the processors contained in the user's computing apparatus 102 may implement or execute the method 300 to automatically identify and display the tags according to the relevance of the identifiers to which the tags are associated based upon the identifiers contained in the privately stored messages.

At step 302, one or more document identifiers of a document, such as a webpage, an e-mail message, etc., are discovered. As described above, the one or more document identifiers may comprise, for instance, URIs, URLs, URNs, or other types of unique identifiers, such as, patent numbers, ISBNs, etc. The one or more document identifiers may be discovered, for instance, through receipt of a user selection of the one or more document identifiers in any of the windows 210, 252 depicted in FIGS. 2A-2C. In another example, the one or more document identifiers may be discovered by scanning through the navigation area window 210 to locate the one or more document identifiers. By way of example, a document identifier may be located in the text box 216, in which case, the document identifier may comprise the URI recited in the text box 216. As another example, the document identifier may be located within the result window 214, in which case, the document identifier may comprise a hypertext link. As a further example, the one or more document identifiers may comprise one or more document identifiers found during a redirection chain.

In any regard, at step 304, the messaging area application 140 uses the discovered one or more document identifiers in scanning through the messages stored in the message store 150. More particularly, the messaging area application 140 scans through the message store 150 to identify those messages that contain the one or more document identifiers discovered at step 302. In addition, or alternatively, if an index of messages was created, the messaging area application 140 may identify those messages that contain the one or more document identifiers by scanning through the index of messages, which may be stored in the message store 150.

At step 306, the messaging area application 140 discovers one or more identifiers in the messages identified at step 304 as containing the one or more document identifiers. Thus, at step 306, for those messages containing the one or more document identifiers, the messaging area application 140 also discovers other identifiers contained those messages. The one or more identifiers may comprise any of the identifiers discussed above with respect to the document identifiers.

At step 308, the messaging area application 140 identifies one or more characteristics of either or both of the one or more identifiers and the messages containing the one or more identifiers. The one or more characteristics may include, for instance, the number of messages containing each of the one or more identifiers, the dates on which the messages were received, the senders of the messages, etc. By way of particular example, the messaging area application 140 may consider each message containing a particular identifier as a vote for that identifier and may count the number of votes as the total number of messages containing each of the one or more identifiers.

At step 310, the messaging area application 140 creates tags associated with the one or more identifiers. Generally speaking, the tags are configured to substantially distinguish the one or more identifiers from each other. According to an example, the tags comprise textual descriptors of the identifiers, such as, parts of the identifiers, the identifiers themselves, etc. By way of particular example, the tags comprise the last segments of the URLs forming the identifiers. In addition, the tags may also comprise hyperlinks, such that, selection or activation of the tags results in the document identified by the identifier associated with the selected tag being displayed in the result window 214.

At step 310, the messaging area application 140 may also apply at least one distinguishing feature to one or more of the tags according to the one or more characteristics of either or both of the identifiers and the messages containing the identifiers identified at step 308. The distinguishing features may be applied to differentiate the tags from each other, and may include, for instance, font sizes, colors, highlighting, underlining, italicizing, or other distinguishing feature.

According to an example, the one or more characteristics may comprise the respective popularities of the identifiers as determined by the number of messages that contain the one or more identifiers. In this example, those tags associated with identifiers that are contained in the most number of messages may have a larger font, a different color, highlighting, underlining, or other distinguishing feature, to distinguish them from those tags associated with identifiers that are contained in a lesser number of messages. Likewise, those tags associated with identifiers that are contained in the least number of messages may have smaller font, different colors, or other feature to distinguish them from those tags associated with identifiers that are contained in a greater number of messages. Various examples of distinguishing features as applied to the tags are depicted in the tag area 222 in FIGS. 2A-2C.

According to another example, the messaging area application 140 may compute weight vectors for each of the identifiers based upon the one or more characteristics. The one or more characteristics may include, for instance, the type of identifiers, the number of messages containing the identifiers, the senders of the messages, the recipients of the messages, etc. By way of particular example, the messaging area application 140 may give different point values to the tags according to the types of messages that contain the associated identifiers as well as point values according to the number of messages that contain the identifiers. In addition, those tags associated with identifiers having the highest point values may be provided with proportionately larger font sizes, for instance.

The one or more characteristics may also include either or both of the senders and recipients of the messages containing the identifiers. In this example, identifiers contained messages sent from certain senders or sent to certain recipients may be given different weights as compared with identifiers contained in other messages. By way of particular example, those tags associated with other identifiers sent from senders or sent to recipients in the user's contact list may be provided with proportionately larger font sizes.

The one or more characteristics may further include the dates and/or times at which the messages containing the identifiers were received or sent. In this example, the identifiers may be given different weights according to the dates in which the messages were received or sent, such that, for instance, those identifiers contained in messages that were received or sent more recently may be given distinguishing features that indicate greater relevance, such as, proportionately larger font sizes.

The one or more characteristics may still further include the number Of different identifiers contained in the messages. In this example, those identifiers contained in messages having a relatively larger number of different identifiers may be more heavily weighted as compared with those identifiers contained in messages having a relatively smaller number of different identifiers. The tags associated with the more heavily weighted identifiers may be given distinguishing features that indicate greater relevance, such as, proportionately larger font sizes.

The one or more characteristics may still further include the presence of the identifiers in the user's browser favorites or history lists. In this example, the messaging area application 140 may be further configured to scan through the user's browser favorites and/or history lists to determine whether the identifiers are contained in either or both of those locations. In addition, those identifiers that are present in either or both of those locations may be weighed more heavily and may be given distinguishing features that indicate greater relevance, such as, proportionately larger font sizes or different colors.

The one or more characteristics may still further include the presence of the one or more identifiers in at least one of a currently-viewed and a previously-viewed document in the message store and at least one of the number of times that and the dates when the at least one of the currently-viewed and previously-viewed document were viewed. In this example, the messaging area application 140 may be further configured to scan through the message store 150 to determine when the messages containing the at least one document identifier were last viewed, how many times the messages were viewed, etc. In addition, those identifiers that are present in a relatively large number of messages that have been viewed recently, for instance, may be weighed more heavily and may be given distinguishing features that indicate greater relevance, such as, proportionately larger font sizes, different colors, etc., and/or displayed with graphical representations that depict the heavier weighting.

According to a further example, the messaging area application 140 may utilize two or more of the characteristics described in the examples above in determining distinguishing features for the various tags at step 310.

At step 312, the messaging area application 140 displays the tags created at step 310 in the tag area 222, for instance, as depicted in any of FIGS. 2A-2C. The messaging area application 140 may display the tags in alphabetical order, in order of either increasing or decreasing relevance as determined, for instance, from the number of identifiers to which the tags are associated contained in the messages, etc.

In addition or alternatively to any of the examples above, the messaging area application 140 may determine the respective weights of the one or more identifiers and may display only those tags associated with identifiers whose weights exceed a predetermined threshold.

In addition or alternatively to any of the examples above, the messaging area application 140 may display temporal relationships of the identifiers. The temporal relationships may indicate, for instance, the frequency with which the identifiers have occurred in the user's messages and/or browsing history. The temporal relationships may also indicate the time in which the latest messages containing the identifiers were received into the message store 150. In a first example, the temporal relationships may be displayed as graphs located adjacent to respective ones of the tags, for instance, as depicted in FIG. 2C. In a second example, the temporal relationships may be depicted by varying the transparencies of the tags, such as, by causing the tags associated with identifiers to become gradually more transparent as the messages in which they are contained become older.

The messaging area application 140 may optionally display the messages identified at step 304 as containing the one or more document identifiers in the messaging window 226. According to an example, the messaging area application 140 may display links to the actual messages in the messaging area window 220. The links may recite, for instance, summaries of the messages, text from the subjects of the messages, author and/or recipient information, the date when the message was either received or sent, etc. As such, a user may select one or more of the links to the messages 224a-224c in order to view the entire text of those messages 224a-224c.

As an alternative to the links to the messages, the messages 224a-224c may comprise reduced versions of the actual messages. The reduced versions may be displayed as, for instance, the heading information from the messages 224a-224c, the portions of the messages 224a-224c that recite the document identifier(s), etc.

By way of a particular example, in the event that a document identifier comprises the URL of the document or an object 218a contained in the document being displayed in the navigation area result window 214, the messaging area application 140 may automatically discover that URL and may automatically display all of the messages (or links to those message) stored in the message store 150 that contain that URL. In this regard, all of the messages deemed to be relevant to the document being displayed in the navigation area result window 214 are automatically displayed to the user in the messaging window 226.

As such, the system 100 may be implemented as an effective collaboration tool because the system 100 enables users to quickly identify all of the messages that have been received from or sent to other users that contain the document identifier(s). In addition, the messages may be arranged in reverse chronological order to enabled users to identify which of the messages are the most current. The system 100 also provides users with a listing of additional identifiers (tags) that are relevant to the document identifier(s) of the currently viewed document. In addition, the listing of additional identifiers (tags) may also show the level of relevance that each of the additional identifiers has with respect to the document identifier(s).

According to another example, the messages 224a-224c displayed in the messaging window 226 may comprise the most recent messages in respective message threads. In this regard, the messaging area application 140 is configured to identify which message of a plurality of messages along a common thread, for instance, those messages containing the same document identifier(s), is the most recent and to display that message instead of all of the messages along the common thread. In addition, the messaging area application 140 is configured to tag the messages identified as not being the most recent as having been replaced by the most recent message. As such, if a user comes across a message that is not the most recent in a particular thread, that message will notify the user that one or more recent messages are available.

As a yet further example, the messaging area application 140 may track the identifiers, such as, the URLs of web pages in a chain that follows a redirection operation. In this example, the messaging area application 140 may locate all of the messages 224a-224c containing the URLs in the redirect chain and may display those messages 224a-224d in the messaging window 226. In addition, the messaging area application 140 may consider the identifiers in the redirect chain as being synonymous with each other and a single tag may be created for those identifiers at step 310.

In addition, or alternatively, one or more objects 218a-218d contained in the navigation area result window 214 may have their own respective document identifiers. The document identifiers may comprise URIs, URLs, patent numbers, serial numbers, or other forms of uniquely identifying the various objects 218a-218d, such as, a hypertext link. In addition, if the document includes temporally varying content, such as a video, then each time segment may also be identified with its own respective identifier. According to an example, the objects 218a-218d may also comprise document identifiers and the messaging area application 140 may perform the method 400 on the objects 218a-218d in similar manners to those discussed above. In this regard, the messaging area application 140 may create and display tags associated with document identifiers found in messages that contain the objects 218a-218d.

A standard way to identify individual parts of a larger document is to construct an identifier by taking the identifier for the document and appending a hash sign followed by a local identifier for a fragment of the document. In HTML documents those fragments within the document can be labeled with anchor tags 228a-228c. The messaging area application 140 may display either or both of the messages 224a-224c identified as containing the document identifier and the messages 224b-224c containing the fragment identifiers corresponding to one or more of the anchor tags 228a-228c in objects 218a-218c. In instances where the messaging area application 140 displays messages 224a-224c containing the fragment identifiers of a plurality of objects 218a-218c, the messaging area application 140 may also display an indicator 232 that identifies which of the messages 224a-224c currently being displayed in the messaging window 226 contains the fragment identifier of an object that is currently of interest. In addition, or alternatively, the messaging area application 140 may sort the messages 224a-224c according to the fragment identifiers contained in the messages 224a-224c.

The messaging area window 220 may also include visual separators 234 between messages about different objects. Each separator 234 may link to the corresponding fragment identifier. For example, the separator 234 may link to anchor tag 228a. By way of example, if the user selected the separator 234, and it linked to the anchor tag 228c, then the navigation area window 210 would update to show the selected object 218c, the URL window 216 would be updated with the appropriate fragment identifier from the anchor tag 228c, the tag cloud would be updated with tags relevant to the selected object 218c, and the highlight 232 would move next to message 224b.

According to an example, the fragment identifiers need not be contained within the document. By way of a particular example, each segment of a video being played in the navigation area window 210 may have its own respective fragment identifier. In this example, as the video is played, the sections, and thus, the fragment identifier changes. In response to the fragment identifier changes, the messaging area application 140 highlights messages containing the different fragment identifiers with the indicator 232 in the messaging window 226. In addition, or alternatively, the messaging area application 140 may actively vary the tags displayed in the tag area 222 in response to the changes in the fragment identifier. Moreover, the messages 224a-224c displayed in the messaging window 226 may also be actively varied, such that, only those messages 224a-224c containing the current fragment identifier are displayed concurrently with the respective video sections.

According to a further example, the messaging area application 140 may display documents associated with identifiers contained in the messages 224a-224c. In this example, a user may select an identifier, which may comprise a hypertext link, in a message 224a and the messaging area application 140 may cause the document associated with the identifier to be displayed in the navigation area window 210. Moreover, the messaging area application 140 may create a new set of tags associated with the new document displayed in the navigation area window 210 through implementation of the method 300.

Small Screen Devices

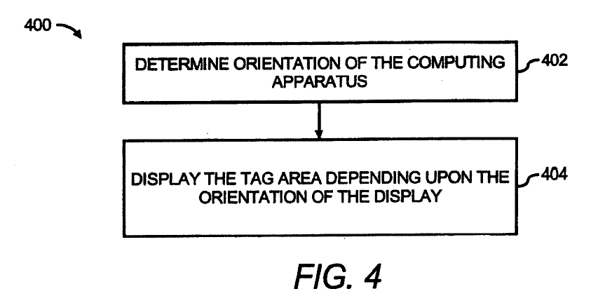

Turning now to FIG. 4, there is shown a flow diagram of a method 400 of displaying a tag area on a computing apparatus 102 having a relatively small display, according to an example. More particularly, the one or more processors may implement or execute the method 400 to vary the content displayed on the display depending upon the orientation of a computing apparatus 102 having a relatively small display, such as, a handheld personal computer, a portable digital assistant, a cellular telephone, or other web-enabled device.

At step 402, the orientation of the computing apparatus 102 is determined. According to an example, the computing apparatus 102 includes one or more sensors configured to detect the orientation of the computing apparatus 102. The one or more sensors may comprise any reasonably suitable known mechanism for determining the orientation of the computing apparatus 102. By way of example, the one or more sensors may comprise accelerometers, optical devices, etc.

In addition, at step 404, the messaging area application 140 displays the tag area 222 on the display of the computing apparatus 102 based upon the detected orientation of the computing apparatus 102. More particularly, for instance, the messaging area application 140 may display the tag area 222 in a portrait orientation when the computing apparatus 102 is in the first orientation and may display the tag area 222 in a landscape orientation when the computing apparatus 102 is in the second orientation.

Expanded Search

In addition to searching the message store 150, the messaging area application 140 may be configured to search for messages containing the one or more identifiers in other content repositories. The other content repositories may be stored, for instance, locally on the user's computing apparatus 102, in a shared intranet file system, mailing list repositories, or in servers accessible over the Internet. By way of example, a user may provide the messaging area application 140 with a list of favorite blogs and the messaging area application 140 may also search through those blogs to determine whether there are entries containing the one or more document identifiers

Tracking Metrics

The content of the message store 150 may be queried to create views over the messaging data which may not already be supported by the messaging application 110. For example, the frequency with which a particular identifier has been referred to in messages, or all the messages sent today which refer to a URL may be graphically displayed. This may be achieved by querying the message store 150 and using the results to generate a web page for display in the navigation area window 210.

Conclusion

Some or all of the operations set forth in the methods 300 and 400 may be contained as utilities, programs, or subprograms, in any desired computer accessible medium. In addition, some or all of the methods 300 and 400 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

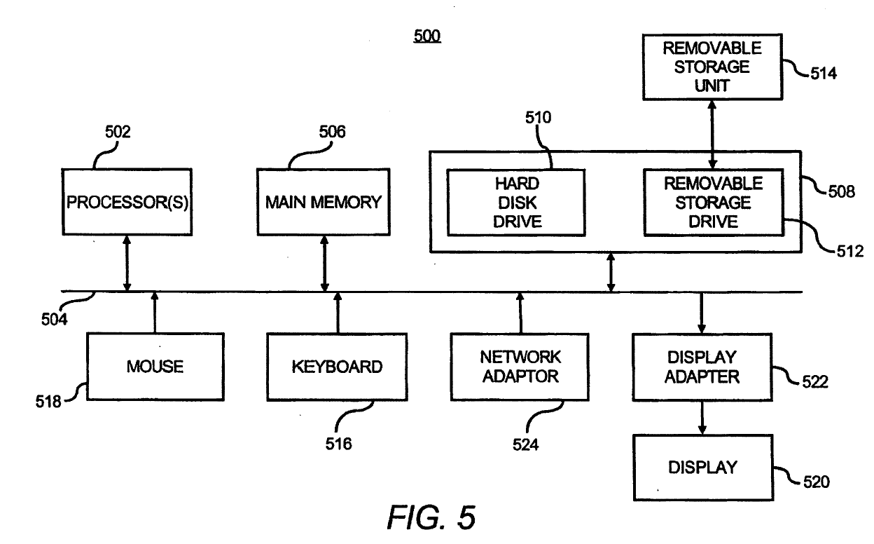

FIG. 5 illustrates a block diagram of a computing apparatus 500, such as the computing apparatus 102 depicted in FIG. 1, according to an example. In this respect, the computing apparatus 500 may be used as a platform for executing one or more of the functions described hereinabove with respect to the computing apparatus 102.

The computing apparatus 500 includes one or more processors 502. The processor(s) 502 may be used to execute some or all of the steps described in the methods 300 and 400. Commands and data from the processor(s) 502 are communicated over a communication bus 504. The computing apparatus 500 also includes a main memory 506, such as a random access memory (RAM), where the program code for the processor(s) 502, may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc., where a copy of the program code for the methods 300 and 400 may be stored.

The removable storage drive 510 reads from and/or writes to a removable storage unit 514 in a well-known manner. User input and output devices may include a keyboard 516, a mouse 518, and a display 520. A display adaptor 522 may interface with the communication bus 504 and the display 520 and may receive display data from the processor(s) 502 and convert the display data into display commands for the display 520. In addition, the processor(s) 502 may communicate over a network, for instance, the Internet, LAN, etc., through a network adaptor 524.

It will be apparent to one of ordinary skill in the art that other known electronic components may be added or substituted in the computing apparatus 800. It should also be apparent that one or more of the components depicted in FIG. 5 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A computerized method of identifying and displaying tags that represent respective identifiers in messages privately stored in a message store for restricted access by a user, said method comprising:
discovering at least one document identifier;
scanning through the message store to identify messages containing the at least one document identifier;
discovering one or more identifiers in the messages identified as containing the at least one document identifier;
creating respective tags associated with the one or more identifiers; and
displaying the tags in a tag area.

2. The method according to claim 1, further comprising:
identifying one or more characteristics of either or both of the one or more identifiers and the messages identified as containing the at least one document identifier, wherein creating respective tags further comprises applying at least one distinguishing feature to one or more of the tags based upon the one or more identifying characteristics.

3. The method according to claim 2, wherein the one or more characteristics comprise a relevance of each of the one or more identifiers to the at least one document identifier, wherein the relevance of each of the one or more identifiers is based upon the number of messages identified as containing each of the one or more identifiers, and wherein creating respective tags further comprises applying the at least one distinguishing feature to one or more of the tags according to the number of messages containing the one or more identifiers.

4. The method according to claim 2, wherein the one or more characteristics comprise a relevance of each of the one or more identifiers to the at least one document identifier, wherein the relevance of each of the one or more identifiers is based upon the times at which the identified messages were either sent from or received by a messaging application, and wherein creating respective tags further comprises applying the at least one distinguishing feature to one or more of the tags according to the times at which the identified messages were sent from or received by the messaging application.

5. The method according to claim 2, wherein the one or more characteristics comprise either or both of senders and recipients of the identified messages, and wherein creating respective tags further comprises applying the at least one distinguishing feature to one or more of the tags according to either or both of the senders and recipients of the identified messages.

6. The method according to claim 2, wherein the one or more characteristics comprise the number of identifiers contained in the identified messages, and wherein creating respective tags further comprises applying the at least one distinguishing feature to one or more of the tags according to the number of identifiers contained in the identified messages.

7. The method according to claim 2, wherein the one or more characteristics comprise a presence of the one or more identifiers in at least one of the user's browser favorites and history lists, and wherein creating respective tags further comprises applying the at least one distinguishing feature to one or more of the tags according to the presence of the one or more identifiers in at least one of the user's browser favorites and history lists.

8. The method according to claim 2, wherein the one or more characteristics comprise a presence of the one or more identifiers in at least one of a currently-viewed and a previously-viewed document in the message store and at least one of the number of times that and the dates when the at least one of the currently-viewed and previously-viewed document were viewed, and wherein creating respective tags further comprises applying the at least one distinguishing feature to one or more of the tags according to the presence of the one or more identifiers in at least one of the currently-viewed and the previously-viewed document and at least one of the number of times that and the dates when the at least one of the currently-viewed and previously-viewed document were viewed.

9. The method according to claim 2, further comprising:
computing weighted vectors for the one or more identifiers, wherein the weighted vectors are computed based upon a plurality of the characteristics of the one or more identifiers, and wherein creating respective tags further comprises applying the at least one distinguishing feature to one or more of the tags according to the weighted vectors.

10. The method according to claim 2, further comprising:
comparing the number of messages containing each of the one or more identifiers with each other;
dividing the tags associated with each of the one or more identifiers into a plurality of predetermined categories based upon the number of messages containing each of the one or more identifiers, wherein each of the predetermined categories includes a different distinguishing feature.

11. The method according to claim 1, wherein creating respective tags comprises creating the tags from at least a portion of the respective one or more identifiers.

12. The method according to claim 2, wherein displaying the tags in a tag area further comprises displaying the tags in the form of at least one of a tag cloud and a graphical representation of the distinguishing features, and wherein displaying the tags further comprises displaying the tags in at least one of a messaging window and a pop-up window.

13. The method according to claim 12, wherein displaying the tags further comprises displaying temporal relationships of the identifiers in the at least one of the tag cloud and the graphical representation.

14. The method according to claim 1, further comprising:
displaying the messages from the message store identified as containing the at least one document identifier in the messaging area window, wherein the messages include one or more identifiers displayed as hypertext links;
in response to receipt of a command to activate a hypertext link contained in a message, displaying the document associated with the activated hypertext link in the navigation area result window;
discovering at least one document identifier of the document displayed in a navigation area result window;
scanning through the message store to identify messages containing the at least one document identifier;
discovering one or more identifiers in the messages identified as containing the at least one document identifier;
creating respective tags associated with the one or more identifiers; and
displaying the tags in a tag area.

15. A computerized system for identifying and displaying tags that represent respective identifiers in messages that contain at least one identifier, said system comprising:
a message store privately accessible by a user;
a messaging application plug-in for at least one of storing and updating messages sent from and received by a messaging application in the message store; and
a messaging area application configured to discover at least one document identifier, wherein the messaging area application is further configured to scan through the message store to identify the messages containing the at least one document identifier, to discover one or more identifiers in the messages identified as containing the at least one document identifier, to create respective tags associated with the one or more identifiers, and to display the tags in a tag area.

16. The computerized system according to claim 15, wherein the messaging area application is further configured to identify one or more characteristics of either or both of the one or more identifiers and the messages identified as containing the at least one document identifier, and to create respective tags by applying at least one distinguishing feature to one or more of the tags based upon the one or more identifying characteristics.

17. The computerized system according to claim 16, wherein the one or more characteristics comprise a relevance of each of the one or more identifiers to the at least one document identifier, and wherein the messaging area application is further configured to apply the at least one distinguishing feature to one or more of the tags based upon the relevance of each of the one or more identifiers to the least one document identifier.

18. The computerized system according to claim 16, wherein the messaging area application is further configured to compute weighted vectors for each of the one or more identifiers based upon a plurality of the characteristics of the one or more identifiers, and to apply the at least one distinguishing feature to one or more of the tags according to the weighted vectors.

19. The computerized system according to claim 16, wherein the at least one distinguishing feature comprises at least one of font size, bold-facing, color, underlining, italicizing, and graphical representations of the tags.

20. The computerized system according to claim 15, wherein the messaging area application is further configured to display the tags in the form of at least one of a tag cloud and a graphical representation of the distinguishing feature and in at least one of a messaging window and a pop-up window.

21. A computer readable storage medium on which is embedded one or more computer programs, said one or more computer programs implementing a method of identifying and displaying tags that represent respective identifiers in messages privately stored in a message store for restricted access by a user, said one or more computer programs comprising a set of instructions for:
discovering at least one document identifier;
scanning through the message store to identify messages containing the at least one document identifier;
discovering one or more identifiers in the messages identified as containing the at least one document identifier;
creating respective tags associated with the one or more identifiers, wherein at least one of the respective tags includes a distinguishing feature with respect to the remaining respective tags; and
displaying the tags in a tag area.
